(19) United States
(12) Patent Application Publication
(10) Pub. No.: US 2018/0099530 A1
(43) Pub. Date: Apr. 12, 2018

(54) PNEUMATIC TIRE

(71) Applicant: Toyo Tire & Rubber Co., Ltd., Itami-shi (JP)

(72) Inventor: Isao Yonetsu, Itami-shi (JP)

(73) Assignee: Toyo Tire & Rubber Co., Ltd., Itami-shi (JP)

(21) Appl. No.: 15/704,120

(22) Filed: Sep. 14, 2017

(30) Foreign Application Priority Data
Oct. 11, 2016 (JP) 2016-199968

(51) Int. Cl. B60C 13/00; B29D 30/72

(52) U.S. Cl. CPC B60C 13/001; B29D 2030/726; B29D 30/72

(57) ABSTRACT

In the pneumatic tire where a mark is formed on a surface of the side wall portion, the mark is formed such that one end portion and the other end portion of the mark in at least one direction of a tire meridian direction, a tire circumferential direction or an oblique direction inclined with respect to the tire meridian direction or the tire circumferential direction are recessed with respect to the surface of the side wall portion, a center portion of the mark in the at least one direction is raised with respect to the surface of the side wall portion, and a height of a surface of the mark with respect to the surface of the side wall portion is gradually increased toward the center portion from the one end portion and the other end portion.

### CROSS-REFERENCE TO RELATED APPLICATIONS

This application is based upon and claims the benefit of priority from the prior Japanese Patent Application No. 2016-199968, filed on Oct. 11, 2016; the entire contents of which are incorporated herein by reference.

### BACKGROUND

### 1. Field of the Invention

The present invention relates to a pneumatic tire.

### 2. Related Art

In general, on a surface of a side wall portion of a pneumatic tire, to display a manufacturer, a brand, a kind, a size and the like of the tire, a mark such as a letter, a symbol or a figure is formed. The mark is formed in a raised manner from the surface of the side wall portion, and various provisions have been made to enhance visibility of the mark (see JP-A-10-086615 and JP-A-2012-131283).

For example, JP-A-10-086615 discloses the pneumatic tire where a surface of a side wall portion and an outer surface profile line of a mark in a tire radial cross section or in a tire circumferential cross section are set not to be parallel to each other. To be more specific, a height of the mark raised from the surface of the side wall portion is set such that the height is gradually increased or decreased from one end to the other end in a tire meridian direction of the mark or in a tire circumferential direction of the mark, or the height of the raised mark is gradually decreased or increased from one end to the center and from the other end to the center.

Based on the technique described in JP-A-10-086615, to further enhance visibility of the mark, the further increase of a projecting height of the mark from the surface of the side wall portion is considered. However, when the projection height is excessively large, a change in thickness of the side wall portion in the tire circumferential direction is increased due to the mark and hence, there arises a drawback such as a drawback that a mass balance is collapsed or a drawback that a recess is easily formed on a tire inner surface.

It is an object of an embodiment of the present invention to provide a pneumatic tire which can enhance visibility of a mark such as a letter, a symbol or a figure formed on a side wall portion.

### SUMMARY

According to an aspect of the present invention, there is provided a pneumatic tire where a mark is formed on a surface of a side wall portion, wherein the mark is formed such that one end portion and the other end portion of the mark in at least one direction of a tire meridian direction, a tire circumferential direction or an oblique direction inclined with respect to the tire meridian direction or the tire circumferential direction are recessed with respect to the surface of the side wall portion, a center portion of the mark in the at least one direction is raised with respect to the surface of the side wall portion, and a height of a surface of the mark with respect to the surface of the side wall portion is gradually increased toward the center portion from the one end portion and the other end portion.

According to another aspect of the present invention, there is provided a pneumatic tire where a mark is formed on a surface of a side wall portion, wherein the mark is formed such that one end portion and the other end portion of the mark in at least one direction of a tire meridian direction, a tire circumferential direction or an oblique direction inclined with respect to the tire meridian direction or the tire circumferential direction are raised with respect to the surface of the side wall portion, a center portion of the mark in the at least one direction is recessed with respect to the surface of the side wall portion, and a height of a surface of the mark with respect to the surface of the side wall portion is gradually decreased toward the center portion from the one end portion and the other end portion.

According to still another aspect of the present invention, there is provided a pneumatic tire where a mark is formed on a surface of a side wall portion, wherein the mark is formed such that one end portion of the mark in at least one direction of a tire meridian direction, a tire circumferential direction or an oblique direction inclined with respect to the tire meridian direction or the tire circumferential direction is raised with respect to the surface of the side wall portion, the other end portion of the mark in the at least one direction is recessed with respect to the surface of the side wall portion, and a height of a surface of the mark with respect to the surface of the side wall portion is gradually decreased toward the other end portion from the one end portion.

### BRIEF DESCRIPTION OF THE DRAWINGS

FIG. 1 is a side view of a main part of a pneumatic tire according to an embodiment;

FIG. 2 is a perspective view showing a mark of a pneumatic tire according to a first embodiment;

FIG. 3 is a cross-sectional view of the pneumatic tire taken along a line III-III in FIG. 2;

FIG. 4 is an enlarged view of a main part in FIG. 3;

FIG. 5 is a perspective view showing a mark of a pneumatic tire according to a second embodiment;

FIG. 6 is a cross-sectional view taken along a line VI-VI in FIG. 5;

FIG. 7 is a perspective view showing a mark of a pneumatic tire according to a third embodiment;

FIG. 8 is a cross-sectional view taken along a line VIII-VIII in FIG. 7;

FIG. 9 is a perspective view showing a mark of a pneumatic tire according to a fourth embodiment;

FIG. 10 is a cross-sectional view taken along a line X-X in FIG. 9;

FIG. 11 is a perspective view showing a mark of a pneumatic tire according to a fifth embodiment;

FIG. 12 is a cross-sectional view taken along a line XII-XII in FIG. 11;

FIG. 13 is a perspective view showing a mark of a pneumatic tire according to a sixth embodiment;

FIG. 14 is a cross-sectional view taken along a line XIV-XIV in FIG. 13;

FIG. 15 is a cross-sectional view showing a mark of a pneumatic tire according to a seventh embodiment;

FIG. 16 is a perspective view showing a mark of a pneumatic tire according to an eighth embodiment;

FIG. 17 is a cross-sectional view taken along a line XVII-XVII in FIG. 16;

FIG. 18 is a perspective view showing a mark of a pneumatic tire according to a ninth embodiment; and

FIG. 19 is a cross-sectional view taken along a line XIX-XIX in FIG. 18.

### DETAILED DESCRIPTION

Hereinafter, embodiments are described with reference to drawings.

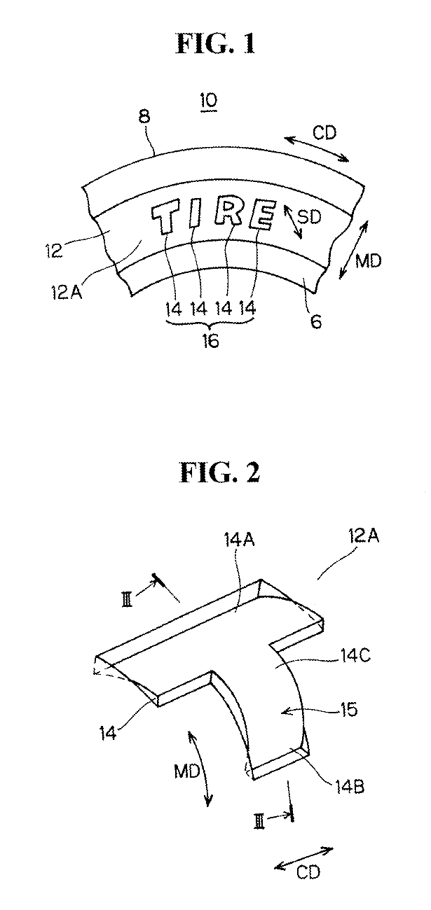

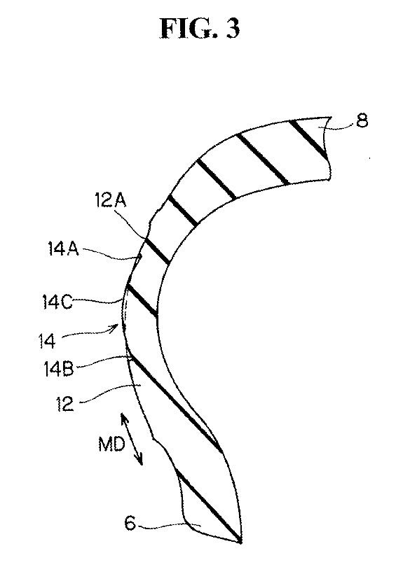

FIG. 1 is a view showing a side surface of a pneumatic tire 10 according to an embodiment. In FIG. 1, a row of marks 16 formed of a plurality of marks 14 is formed on a surface of a side wall portion 12. In general, the pneumatic tire 10 is formed of a tread portion 8 which forms a ground contact surface, a pair of left and right bead portions 6, and a pair of left and right side wall portions 12 which is disposed between the tread portions 8 and the bead portions 6 (see FIG. 3). This embodiment is characterized by a mark 14 formed on an outer surface of at least one side wall portion 12.

As shown in FIG. 1, in this embodiment, as a row of marks 16, “TIRE” formed by arranging respective marks 14, that is, “T”, “I”, “R” and “E” in a tire circumferential direction CD is formed on the surface of the side wall portion 12. The mark 14 is a letter (including a number), a symbol, a figure or the like. In this embodiment, the marks 14 are the respective display elements which form the row of marks 16. However, display information may be formed of only one mark. The row of marks 16 is a certain concept which is formed by gathering the plurality of marks 14. For example, as such a certain concept, various display information such as a name of a manufacturer, a brand, a kind or a size of the tire can be named. In general, the row of marks 16 is formed by arranging a plurality of marks 14 along the tire circumferential direction CD.

### First Embodiment

As shown in FIG. 2 to FIG. 4, in a pneumatic tire according to a first embodiment, a mark 14 is formed such that an outer-peripheral-side end portion 14A and an inner-peripheral-side end portion 14B of the mark 14 in a tire meridian direction MD are recessed or depressed with respect to a surface 12A of a side wall portion 12, and a center portion 14C of the mark 14 in the tire meridian direction MD is raised or elevated with respect to the surface 12A of the side wall portion 12. The mark 14 is formed such that a height of a surface 15 of the mark 14 with respect to the surface 12A of the side wall portion 12 is gradually increased from the outer-peripheral-side end portion 14A and the inner-peripheral-side end portion 14B to the center portion 14C.

In this disclosure, the height of the surface 15 of the mark 14 means the position of the surface 15 of the mark 14 with respect to the surface 12A of the side wall portion 12 in a normal direction of the surface 12A of the side wall portion 12. The larger a recessed amount of the mark 14, the lower the height of the surface 15 becomes, while the larger a raised amount of the mark 14, the higher the height of the surface 15 becomes. Accordingly, the surface 15 of the mark 14 is formed such that the surface 15 gradually approaches the surface 12A of the side wall portion 12 as the surface 15 extends from the outer-peripheral-side recessed end portion 14A and the inner-peripheral-side recessed end portion 14B toward the center portion 14C, the surface 15 is further gradually raised beyond the surface 12A of the side wall portion 12, and a projection amount of the surface 15 from the surface 12A of the side wall portion 12 becomes maximum at the center portion 14C.

To be more specific, with respect to the letter “T” which is the mark 14, the upper end portion 14A and the lower end portion 14B in a letter height direction are recessed in a concave shape with respect to the surface 12A of the side wall portion 12, and the center portion 14C in the letter height direction is raised in a convex shape with respect to the surface 12A of the side wall portion 12. The height of the surface 15 of the mark 14 is gradually increased from the upper end portion 14A to the center portion 14C, and is gradually decreased from the center portion 14C to the lower end portion 14B. In this embodiment, in a letter width direction (in the tire circumferential direction CD), the height of the surface 15 of the mark 14 is set to a fixed value.

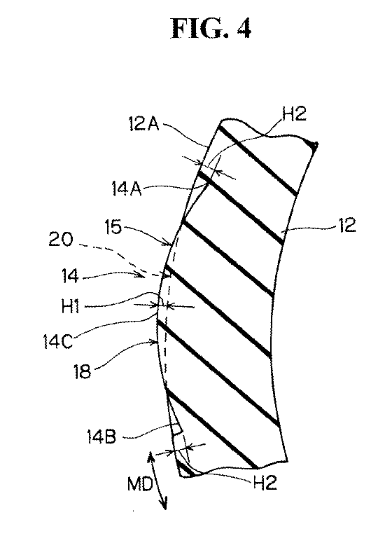

As shown in FIG. 4, in a cross section of the mark 14 in a tire meridian direction (that is, in a cross section taken along the tire meridian direction, equal to a cross section in a tire radial direction), a mark profile line 18 which forms a profile of the mark 14 on a surface 15 side is formed of a curve having the center of curvature inside the tire. A reference profile line 20 which forms a profile of the surface 12A of the side wall portion 12 is also formed of a curve having the center of curvature inside the tire. The mark profile line 18 has the smaller center of curvature than the reference profile line 20. Accordingly, at both end portions 14A, 14B in the tire meridian direction MD, the mark profile line 18 is positioned more inside of the tire than the reference profile line 20 so that the surface 15 of the mark 14 is recessed. On the other hand, at the center portion 14C in the tire meridian direction MD, the mark profile line 18 is positioned more outside of the tire than the reference profile line 20 so that the surface 15 of the mark 14 is raised.

In this disclosure, the reference profile line 20 in cross section in the tire meridian direction is a profile line obtained by smoothly connecting portions of the surface 12A by excluding partial unevenness such as the mark 14 and a decorative serration from the surface 12A of the side wall portion 12.

Although a maximum raised amount H1 of the mark 14 (in FIG. 4, a projection amount of the mark 14 with respect to the reference profile line 20 at the center portion 14C) is not particularly limited, the maximum raised amount H1 is preferably set to a value which falls within a range of from 0.3 to 1.5 mm. Although a maximum recessed amount H2 of the mark 14 (in FIG. 4, a recessed amount of the mark 14 with respect to the reference profile line 20 at the upper end portion 14A and the lower end portion 14B) is not particularly limited, the maximum recessed amount H2 is preferably set to a value which falls within a range of from 0.3 to 1.5 mm. Further, although a ratio (H1/H2) between the maximum raised amount H1 and the maximum recessed amount H2 is not particularly limited, it is preferable that the maximum raised amount H1 and the maximum recessed amount H2 be set approximately equal, that is, the ratio H1/H2 is preferably set to a value which falls within a range of from 6/4 to 4/6. In this manner, by setting the maximum raised amount H1 and the maximum recessed amount H2 approximately equal, the worsening in mass balance in the tire circumferential direction CD caused by the mark 14 can be further suppressed.

In this embodiment, the mark 14 is a plain mark which does not have an uneven pattern such as a serration or a hemming on the surface 15. In FIG. 2 to FIG. 4, the description is made only with respect to the mark 14 formed of the letter ‘T’ in the row of marks 16. However, other marks 14 can be formed in the same manner. Further, the mark 14 having such a recessed and raised configuration as described above can be formed by the transfer of concavity and convexity formed on a mold at the time of forming a pneumatic tire by vulcanization molding.

According to the first embodiment, the mark 14 is formed so as to have the portions 14A, 14B which are recessed with respect to the surface 12A of the side wall portion 12 and the portion 14C which is raised with respect to the surface 12A of the side wall portion 12, and the height of the surface 15 of the mark 14 with respect to the surface 12A of the side wall portion 12 is gradually changed. Accordingly, a deep stereoscopic shape can be imparted to the mark 14 while suppressing a projection amount of mark 14 from the surface 12A of the side wall portion 12. That is, a change in thickness of the side wall portion 12 caused by the mark 14 can be suppressed while imparting a deep stereoscopic shape to the mark 14 and hence, worsening in mass balance in the tire circumferential direction CD can be suppressed whereby the occurrence of a recess on a tire inner surface side can be suppressed. Further, because of formation of shades in the recessed portions 14A, 14B, it is possible to further impart a stereoscopic effect to the mark 14 thus enhancing visibility of the mark 14.

### Second Embodiment

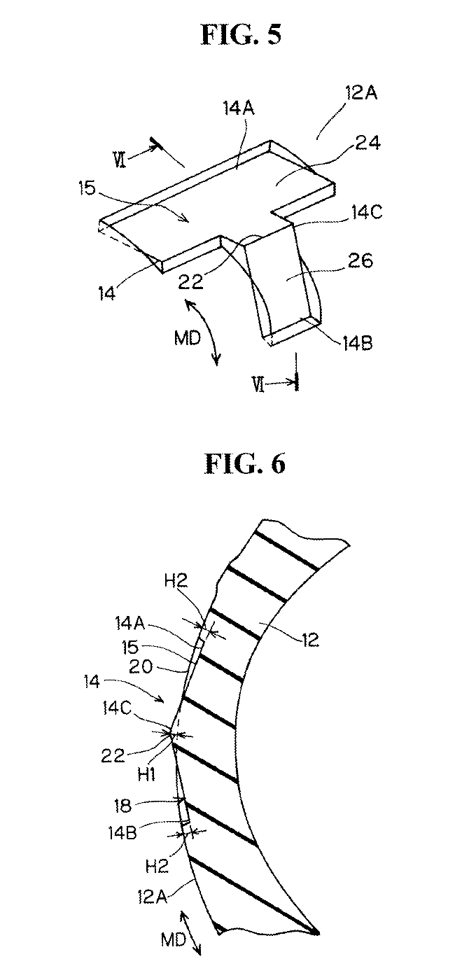

As shown in FIG. 5 and FIG. 6, a mark 14 of a pneumatic tire according to a second embodiment differs from the mark 14 of the first embodiment with respect to a point that a surface 15 of the mark 14 is formed of two planar surfaces in the second embodiment while the surface 15 of the mark 14 is formed of a curved surface in the first embodiment.

To be more specific, in the second embodiment, the surface 15 of the mark 14 is formed of: a planar inclined surface 24 which reaches an outer-peripheral-side end portion 14A from a horizontal ridge line 22 positioned at a center portion 14C; and a planar inclined surface 26 which reaches an inner-peripheral-side end portion 14B from the ridge line 22. In a cross section of the mark 14 in a tire meridian direction shown in FIG. 6, a mark profile line 18 is formed into a straight line shape which is bent in a V shape with the ridge line 22 positioned at the center portion 14C as a peak.

As described above, a surface shape of the mark 14 is not limited to a curved shape, and may be formed of a planar surface. The configuration where the surface shape of the mark 14 is formed of a planar surface as described above is applicable to marks according to third to seventh embodiments described later. Other configurations and advantageous effects of the second embodiment are substantially equal to those of the first embodiment. Accordingly, constitutional elements of the second embodiment corresponding to the constitutional elements of the first embodiment are given the same symbols and their description is omitted.

### Third Embodiment

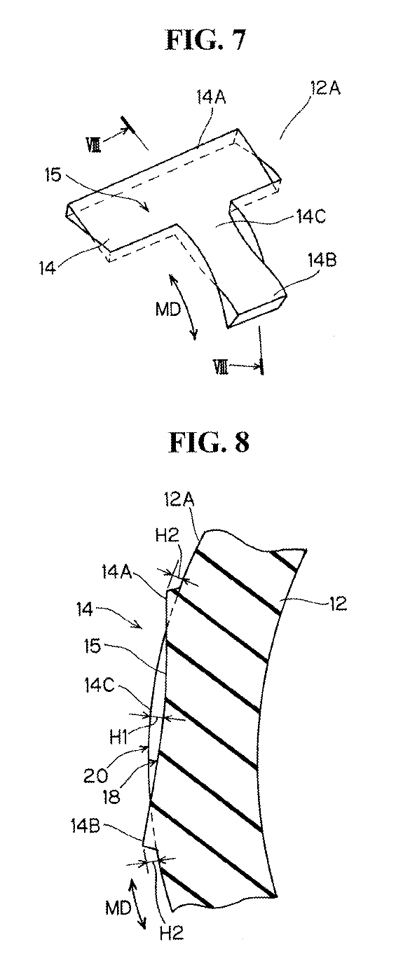

As shown in FIG. 7 and FIG. 8, a mark 14 of a pneumatic tire according to a third embodiment differs from the mark 14 of the first embodiment with respect to a point that both end portions are raised and a center portion is recessed in a tire meridian direction MD in the third embodiment while the both end portions are recessed and the center portion is raised in the tire meridian direction MD in the first embodiment.

That is, in the pneumatic tire according to the third embodiment, the mark 14 is formed such that an outer-peripheral-side end portion 14A and an inner-peripheral-side end portion 14B in the tire meridian direction MD are raised with respect to a surface 12A of a side wall portion 12, and a center portion 14C in the tire meridian direction MD is recessed with respect to the surface 12A of the side wall portion 12. Further, the mark 14 is formed such that a height of a surface 15 of the mark 14 with respect to the surface 12A of the side wall portion 12 is gradually decreased from the outer-peripheral-side end portion 14A and the inner-peripheral-side end portion 14B to the center portion 14C.

To be more specific, with respect to the letter “T” which is the mark 14, the upper end portion 14A and the lower end portion 14B in a letter height direction are raised in a convex shape with respect to the surface 12A of the side wall portion 12, and the center portion 14C in the letter height direction is recessed in a concave shape with respect to the surface 12A of the side wall portion 12. The height of the surface 15 of the mark 14 is gradually decreased from the upper end portion 14A to the center portion 14C, and is gradually increased from the center portion 14C to the lower end portion 14B.

As shown in FIG. 8, in a cross section of the mark 14 in the tire meridian direction, a mark profile line 18 is formed of a curve having the center of curvature outside the tire, and the mark profile line 18 intersects with a reference profile line 20 having a center of curvature inside the tire at two points. With such a configuration, both end portions 14A, 14B in the tire meridian direction MD are positioned more outside of the tire than the reference profile line 20 so that the surface 15 of the mark 14 is raised at both end portions 14A, 14B, while the center portion 14C is positioned more inside of the tire than the reference profile line 20 and hence, the surface 15 of the mark 14 is recessed at the center portion 14C.

As described above, it may be possible to adopt the recessed and raised configuration of the mark 14 where both end portions of the mark 14 in the tire meridian direction MD are raised and the center portion of the mark 14 is recessed. Other configurations and advantageous effects of the third embodiment are substantially equal to those of the first embodiment. Accordingly, constitutional elements of the third embodiment corresponding to the constitutional elements of the first embodiment are given the same symbols and their description is omitted.

### Fourth Embodiment

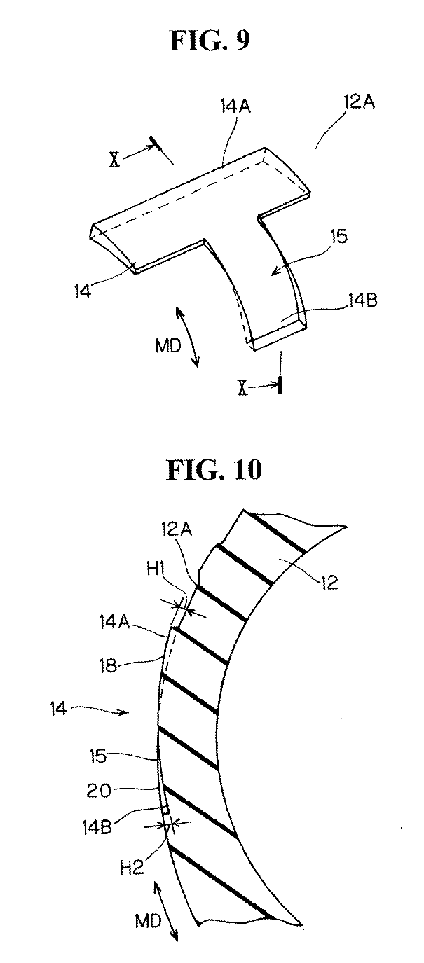

As shown in FIG. 9 and FIG. 10, a mark 14 of a pneumatic tire according to a fourth embodiment differs from the mark 14 of the first embodiment with respect to a point that one end portion is raised and the other end portion is recessed in the tire meridian direction MD in the fourth embodiment while both end portions are recessed and the center portion is raised in the tire meridian direction MD in the first embodiment.

That is, in the pneumatic tire according to the fourth embodiment, the mark 14 is formed such that an outer-peripheral-side end portion 14A in the tire meridian direction MD is raised with respect to a surface 12A of a side wall portion 12, and an inner-peripheral-side end portion 14B is recessed with respect to the surface 12A of the side wall portion 12. Further, the mark 14 is formed such that a height of a surface 15 of the mark 14 with respect to the surface 12A of the side wall portion 12 is gradually decreased from the outer-peripheral-side end portion 14A to the inner-peripheral-side end portion 14B.

To be more specific, with respect to the letter “T” which is the mark 14, the upper end portion 14A in a letter height direction is raised in a convex shape with respect to the surface 12A of the side wall portion 12, and the lower end portion 14B in the letter height direction is recessed in a concave shape with respect to the surface 12A of the side wall portion 12. The height of the surface 15 of the mark 14 is gradually decreased from the upper end portion 14A to the lower end portion 14B.

As shown in FIG. 10, in a cross section of the mark 14 in the tire meridian direction, a mark profile line 18 is formed of a curve having the center of curvature inside the tire, and the center of curvature of the mark profile line 18 is displaced toward the outside in the tire radial direction from the center of curvature of a reference profile line 20. With such a configuration, at the outer-peripheral-side end portion 14A in the tire meridian direction MD, the mark profile line 18 is positioned more outside of the tire than the reference profile line 20 so that the surface 15 of the mark 14 is raised, while at the inner-peripheral-side end portion 14B, the mark profile line 18 is positioned more inside of the tire than the reference profile line 20 so that the surface 15 of the mark 14 is recessed.

As described above, the recessed and raised configuration of the mark 14 is not limited to the case where the center portion in the tire meridian direction MD is raised or recessed with respect to both end portions in the tire meridian direction MD, and may be configured such that the upper end portion 14A is raised and the lower end portion 14B is recessed. Other configurations and advantageous effects of the fourth embodiment are substantially equal to those of the first embodiment, and constitutional elements of the fourth embodiment corresponding to the constitutional elements of the first embodiment are given the same symbols and their description is omitted.

### Fifth Embodiment

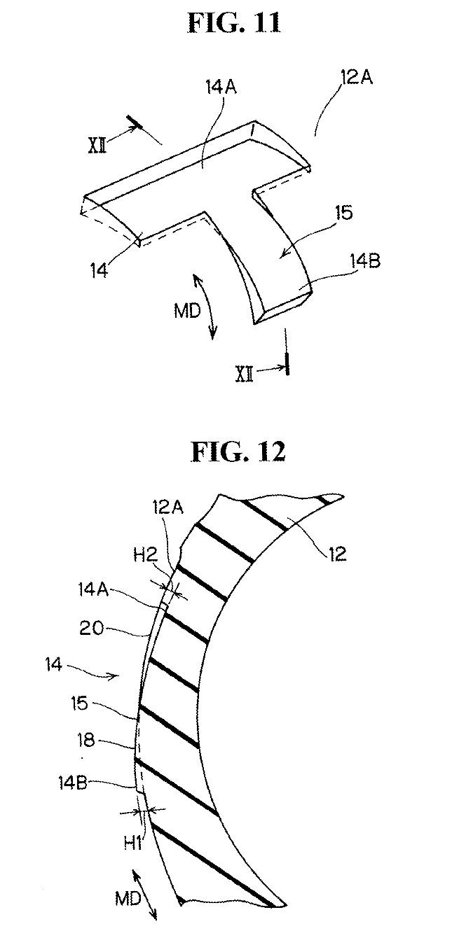

As shown in FIG. 11 and FIG. 12, a mark 14 of a pneumatic tire according to a fifth embodiment differs from the mark 14 of the fourth embodiment with respect to a point that an upper end portion 14A is recessed and a lower end portion 14B is raised in a tire meridian direction MD in the fifth embodiment, while the upper end portion 14A is raised and the lower end portion 14B is recessed in the tire meridian direction MD in the fourth embodiment.

That is, in the pneumatic tire according to the fifth embodiment, the mark 14 is formed such that an outer-peripheral-side end portion 14A in the tire meridian direction MD is recessed with respect to a surface 12A of a side wall portion 12, and an inner-peripheral-side end portion 14B is raised with respect to the surface 12A of the side wall portion 12. Further, the mark 14 is formed such that a height of a surface 15 of the mark 14 with respect to the surface 12A of the side wall portion 12 is gradually increased from the outer-peripheral-side end portion 14A to the inner-peripheral-side end portion 14B.

To be more specific, with respect to the letter “T” which is the mark 14, the upper end portion 14A in a letter height direction is recessed in a concave shape with respect to the surface 12A of the side wall portion 12, and the lower end portion 14B in the letter height direction is raised in a convex shape with respect to the surface 12A of the side wall portion 12. The height of the surface 15 of the mark 14 is gradually increased from the upper end portion 14A to the lower end portion 14B.

As shown in FIG. 12, in a cross section of the mark 14 in the tire meridian direction, a mark profile line 18 is formed of a curve having the center of curvature inside the tire, and the center of curvature of the mark profile line 18 is displaced inward in the tire radial direction from the center of curvature of a reference profile line 20. Accordingly, at the outer-peripheral-side end portion 14A in the tire meridian direction MD, the mark profile line 18 is positioned more inside of the tire than the reference profile line 20 so that the surface 15 of the mark 14 is recessed, while at the inner-peripheral-side end portion 14B, the mark profile line 18 is positioned more outside of the tire than the reference profile line 20 so that the surface 15 of the mark 14 is raised. Other configurations and advantageous effects of the fifth embodiment are substantially equal to those of the fourth embodiment, and constitutional elements of the fifth embodiment corresponding to the constitutional elements of the fourth embodiment are given the same symbols and their description is omitted.

### Sixth Embodiment

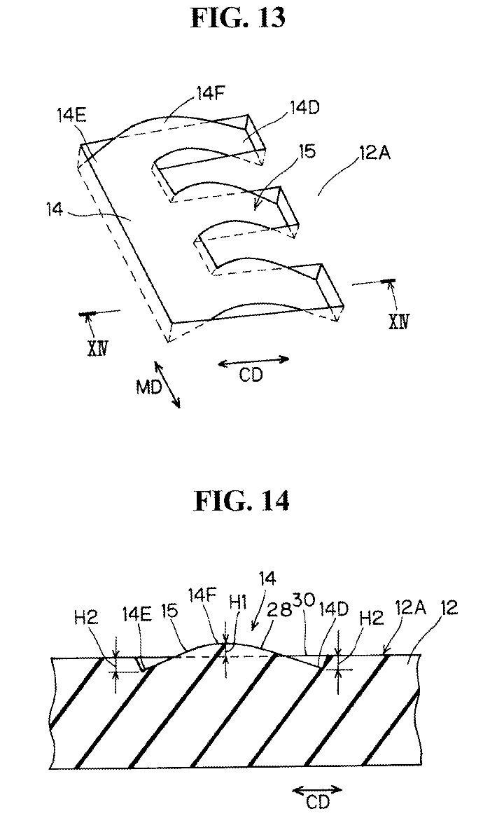

As shown in FIG. 13 and FIG. 14, a mark 14 of a pneumatic tire according to a sixth embodiment differs from the mark 14 of the first embodiment with respect to a point that both end portions are recessed and a center portion of the mark 14 is raised in a tire circumferential direction CD in the sixth embodiment, while both end portions are recessed and the center portion is raised in the tire meridian direction MD in the first embodiment.

That is, in the pneumatic tire according to the sixth embodiment, the mark 14 is formed such that both end portions 14D, 14E in the tire circumferential direction CD are recessed with respect to a surface 12A of a side wall portion 12, and a center portion 14F in the tire circumferential direction CD is raised with respect to the surface 12A of the side wall portion 12. Further, the mark 14 is formed such that a height of a surface 15 of the mark 14 with respect to the surface 12A of the side wall portion 12 is gradually increased from both end portions 14D, 14E to the center portion 14F.

To be more specific, with respect to the letter “E” which is the mark 14, both end portions 14D, 14E in a letter width direction are recessed in a concave shape with respect to the surface 12A of the side wall portion 12, and the center portion 14F in the letter width direction is raised in a convex shape with respect to the surface 12A of the side wall portion 12. A height of the surface 15 of the mark 14 is gradually increased from one end portion 14D to the center portion 14F in the letter width direction, and is gradually decreased from the center portion 14F to the other end portion 14E. In this embodiment, in a letter height direction (tire meridian direction MD), the surface 15 of the mark 14 is set to a fixed height.

As shown in FIG. 14, in a cross section of the mark 14 in the tire circumferential direction (that is, a cross section taken along the tire circumferential direction), a mark profile line 28 which forms a profile of the mark 14 on a surface 15 side is formed into a curve shape projecting toward the outside of the tire. With respect to a straight-line-shaped reference profile line 30 which forms a profile of the surface 12A of the side wall portion 12, the mark profile line 28 is positioned more inside of the tire than the reference profile line 30 at both end portions 14D, 14E in the tire circumferential direction CD so that the surface 15 of the mark 14 is recessed at both end portions 14D, 14E in the tire circumferential direction CD, while the mark profile line 28 is positioned more outside of the tire than the reference profile line 30 at the center portion 14F in the tire circumferential direction CD so that the surface 15 of the mark 14 is raised at the center portion 14F in the tire circumferential direction CD.

As described above, the recessed and raised configuration of the mark 14 is not limited to the case where the recessed and raised configuration is provided in the tire meridian direction MD, and the mark 14 may be configured such that both end portions 14D, 14E are recessed and the center portion 14F is raised in the tire circumferential direction CD. Other configurations and advantageous effects of the sixth embodiment are substantially equal to those of the first embodiment so that constitutional elements of the sixth embodiment corresponding to the constitutional elements of the first embodiment are given the same symbols and their description is omitted.

### Seventh Embodiment

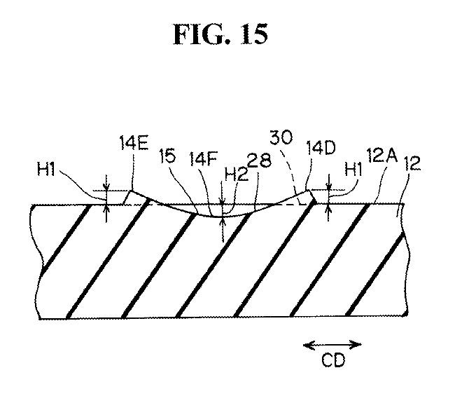

As shown in FIG. 15, a mark 14 of a pneumatic tire according to a seventh embodiment differs from the mark 14 of the sixth embodiment with respect to a point that both end portions are raised and a center portion is recessed in the tire circumferential direction CD in the seventh embodiment, while both end portions are recessed and the center portion is raised in the tire circumferential direction CD in the sixth embodiment.

That is, in the pneumatic tire according to the seventh embodiment, the mark 14 is formed such that both end portions 14D, 14E in the tire circumferential direction CD are raised with respect to a surface 12A of a side wall portion 12, and the center portion 14F in the tire circumferential direction CD is recessed with respect to the surface 12A of the side wall portion 12. Further, the mark 14 is formed such that a height of a surface 15 of the mark 14 with respect to the surface 12A of the side wall portion 12 is gradually decreased from both end portions 14D, 14E to the center portion 14F.

To be more specific, with respect to the letter “E” which is the mark 14, both end portions 14D, 14E in a letter width direction are raised in a convex shape with respect to the surface 12A of the side wall portion 12, and the center portion 14F in the letter width direction is recessed in a concave shape with respect to the surface 12A of the side wall portion 12. A height of the surface 15 of the mark 14 is gradually decreased from one end portion 14D to the center portion 14F in a width direction, and is gradually increased from the center portion 14F to the other end portion 14E.

In a cross section of the mark 14 shown in FIG. 15 taken along the tire circumferential direction, a mark profile line 28 is formed into a curved shape projecting toward the inside of the tire. The mark profile line 28 is positioned more outside of the tire than a reference profile line 30 at both end portions 14D, 14E in the tire circumferential direction CD so that the surface 15 of the mark 14 is raised at both end portions 14D, 14E, and the mark profile line 28 is positioned more inside of the tire than the reference profile line 30 at the center portion 14F so that the surface 15 of the mark 14 is recessed at the center portion 14F.

As described above, the recessed and raised configuration of the mark 14 may be configured such that both end portions in the tire circumferential direction CD are raised and the center portion in the tire circumferential direction CD is recessed. Other configurations and advantageous effects of the seventh embodiment are substantially equal to those of the sixth embodiment, and constitutional elements of the seventh embodiment corresponding to the constitutional elements of the sixth embodiment are given the same symbols and their description is omitted.

### Eighth Embodiment

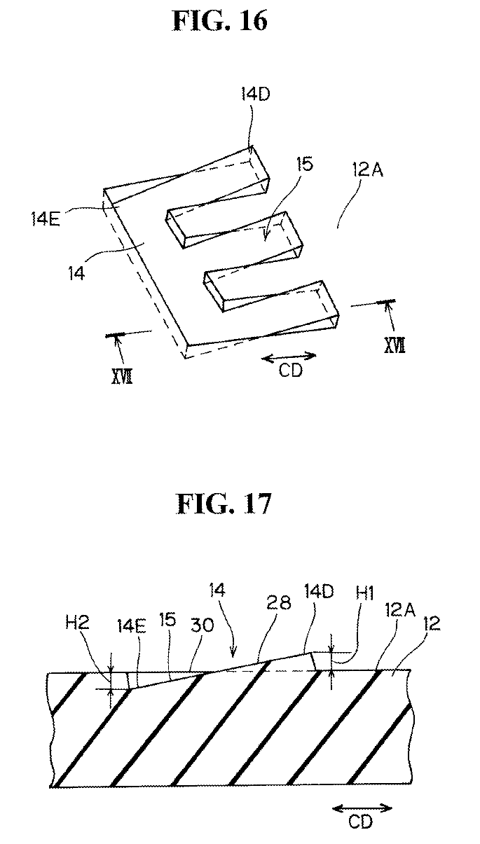

As shown in FIG. 16 and FIG. 17, a mark 14 of a pneumatic tire according to an eighth embodiment differs from the mark 14 of the sixth embodiment with respect to a point that one end portion is raised and the other end portion is recessed in the tire circumferential direction CD in the eighth embodiment while both end portions are recessed and the center portion is raised in the tire circumferential direction CD in the sixth embodiment.

That is, in the pneumatic tire according to the eighth embodiment, the mark 14 is formed such that one end portion 14D in the tire circumferential direction CD is raised with respect to a surface 12A of a side wall portion 12, and the other end portion 14E is recessed with respect to the surface 12A of the side wall portion 12. Further, the mark 14 is formed such that a height of a surface 15 of the mark 14 with respect to the surface 12A of the side wall portion 12 is gradually decreased from one end portion 14D to the other end portion 14E.

To be more specific, with respect to the letter “E” which is the mark 14, one end portion 14D in a letter width direction is raised in a convex shape with respect to the surface 12A of the side wall portion 12, and the other end portion 14E in the letter width direction is recessed in a concave shape with respect to the surface 12A of the side wall portion 12. A height of the surface 15 of the mark 14 is gradually decreased from one end portion 14D to the other end portion 14E in the width direction.

As shown in FIG. 17, in a cross section of the mark 14 in a tire circumferential direction, a mark profile line 28 is formed into a straight line shape inclined with respect to a reference profile line 30. The mark profile line 28 is positioned more outside of the tire than the reference profile line 30 at one end portion 14D in the tire circumferential direction CD so that the surface 15 of the mark 14 is raised, and is positioned more inside of the tire than the reference profile line 30 at the other end portion 14E so that the surface 15 of the mark 14 is recessed.

As described above, the recessed and raised configuration of the mark 14 is not limited to the case where the center portion is raised or recessed with respect to both end portions in the tire circumferential direction CD, and may be configured such that one end portion 14D is raised and the other end portion 14E is recessed. Other configurations and advantageous effects of the eighth embodiment are substantially equal to those of the sixth embodiment, and constitutional elements of the eighth embodiment corresponding to the constitutional elements of the sixth embodiment are given the same symbols and their description is omitted.

### Ninth Embodiment

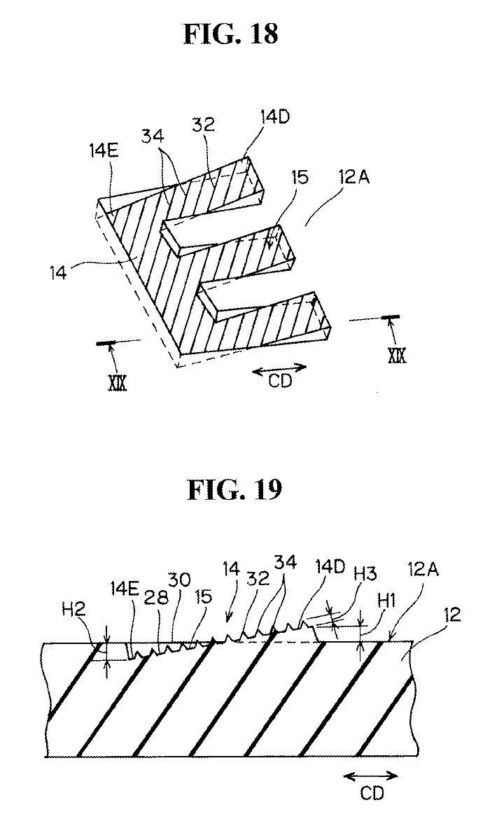

As shown in FIG. 18 and FIG. 19, a mark 14 of a pneumatic tire according to a ninth embodiment differs from the mark 14 of the eighth embodiment with respect to a point that a serration 32 is formed on a surface 15 in the ninth embodiment while the mark 14 is formed of a plain mark in the eighth embodiment.

That is, in the pneumatic tire according to the ninth embodiment, the serration 32 which is formed by arranging a large number of projecting ridges 34 having a fine height parallel to each other at a predetermined interval is formed on the surface 15 of the mark 14. A height H3 of the projecting ridges 34 is set smaller than a maximum raised amount H1 and a maximum recessed amount H2 of the mark 14. For example, the height H3 can be set to a value which falls within a range of from approximately 20 to 50% of the maximum raised amount H1 and the maximum recessed amount H2.

As described above, the mark having the serration 32 on the surface 15 thereof may be adopted as the mark 14. For example, the serration 32 may be formed on any one of the surfaces 15 of the marks 14 according to the above-mentioned first to seventh embodiments. Although not shown in the drawing, a projecting ridge which forms a hemming may be formed on the surface 15 of the mark 14. When an uneven pattern such as a serration or a hemming is formed on the surface 15 of the mark 14, the recessed and raised configuration of the mark 14 may be applied to a surface acquired by excluding such an uneven pattern as the surface 15 of the mark 14.

### OTHER EMBODIMENTS

In the above-mentioned embodiments, the description has been made with respect to the case where the recessed and raised configuration is provided to the mark 14 in the tire meridian direction MD and in the tire circumferential direction CD. However, the recessed and raised configuration may be applied in an oblique direction SD (see FIG. 1) inclined with respect to the tire meridian direction MD or the tire circumferential direction CD.

That is, the mark may be formed such that one end portion and the other end portion in the oblique direction are recessed with respect to the surface of the side wall portion, the center portion in the oblique direction is raised with respect to the surface of the side wall portion, and the height of the surface of the mark with respect to the surface of the side wall portion is gradually increased from one end portion and the other end portion to the center portion. Alternately, the mark may be formed such that one end portion and the other end portion in the oblique direction are raised with respect to the surface of the side wall portion, the center portion in the oblique direction is recessed with respect to the surface of the side wall portion, and the height of the surface of the mark with respect to the surface of the side wall portion is gradually decreased from one end portion and the other end portion to the center portion. Alternately, the mark may be formed such that one end portion in the oblique direction is raised with respect to the surface of the side wall portion, the other end portion in the oblique direction is recessed with respect to the surface of the side wall portion, and the height of the surface of the mark with respect to the surface of the side wall portion is gradually decreased from one end portion to the other end portion.

In this disclosure, the oblique direction may be a direction which is inclined with respect to the tire meridian direction or the tire circumferential direction at a position on the surface of the side wall portion on which the mark is formed. Accordingly, it is also safe to say that the oblique direction is the direction which is inclined with respect to the height direction or the width direction of the mark (for example, the letter). Accordingly, the above-mentioned recessed and raised configuration may be adopted in the direction extending from a left lower portion to a right upper portion of the letter or in the direction extending from a left upper portion to a right lower portion of the letter, that is, the oblique direction of the letter, for example.

Further, the recessed and raised configuration of the mark 14 may be applied in two or more directions selected from the tire meridian direction MD, the tire circumferential direction CD and the oblique direction SD. For example, the recessed and raised configuration may be set in two directions consisting of the tire meridian direction MD and the tire circumferential direction CD. To be more specific, a mark (letter) may be formed such that a peripheral edge portion of the mark is recessed and a center portion of the mark is raised, and a height of a surface 15 of the mark 14 is gradually increased from the peripheral edge portion to the center portion by combining the recessed and raised configuration in the tire meridian direction MD according to the first embodiment (see FIG. 2 to FIG. 4) and the recessed and raised configuration in the tire circumferential direction CD according to the sixth embodiment (see FIG. 13 and FIG. 14) with each other. Alternatively, a mark (letter) may be formed such that a peripheral edge portion of the mark is raised and a center portion of the mark is recessed, and a height of the surface 15 of the mark 14 is gradually decreased from the peripheral edge portion to the center portion by combining the recessed and raised configuration in the tire meridian direction MD according to the third embodiment (see FIG. 7 and FIG. 8) and the recessed and raised configuration in the tire circumferential direction CD according to the seventh embodiment (see FIG. 15) with each other.

As has been described heretofore, according to the above-mentioned embodiments, the mark is formed such that the surface of the mark has a portion raised with respect to the surface of the side wall portion and a portion recessed with respect to the surface of the side wall portion, and a height of the surface of the mark with respect to the surface of the side wall portion is gradually changed. Accordingly, the mark on the side wall portion can exhibit more stereoscopic appearance thus enhancing visibility of the mark.

The above-mentioned respective sizes in this specification are sizes in a normal state where the pneumatic tire is mounted on a normal rim, the pneumatic tire is filled with a normal internal pressure, and no load is applied to the pneumatic tire. The normal rim is a “standard rim” in the JATMA standard, a “Design Rim” in the TRA standard, or a “Measuring Rim” in the ETRTO standard. The normal internal pressure is a “maximum air pressure” in the JATMA standard, a “maximum value” described in “TIRE LOAD LIMITS AT VARIOUS COLD INFLATION PRESSURE” in the TRA standard, or an “INFLATION PRESSURE” in the ETRTO standard.

Although the several embodiments have been described heretofore, these embodiments are merely shown as examples, and are not intended to limit the scope of the present invention. These novel embodiments described herein may be embodied in various other forms, and various omissions, substitutions, changes can be made without departing from the gist of the invention.

What is claimed is:

1. A pneumatic tire where a mark is formed on a surface of a side wall portion, wherein
the mark is formed such that one end portion and the other end portion of the mark in at least one direction of a tire meridian direction, a tire circumferential direction or an oblique direction inclined with respect to the tire meridian direction or the tire circumferential direction are recessed with respect to the surface of the side wall portion, a center portion of the mark in the at least one direction is raised with respect to the surface of the side wall portion, and a height of a surface of the mark with respect to the surface of the side wall portion is gradually increased toward the center portion from the one end portion and the other end portion.

2. The pneumatic tire according to claim 1, wherein an outer-peripheral-side end portion and an inner-peripheral-side end portion of the mark in the tire meridian direction are recessed with respect to the surface of the side wall portion, the center portion of the mark in the tire meridian direction is raised with respect to the surface of the side wall portion, and the mark is formed such that the height of the surface of the mark with respect to the surface of the side wall portion is gradually increased toward the center portion from the outer-peripheral-side end portion and the inner-peripheral-side end portion.

3. The pneumatic tire according to claim 1, wherein both end portions of the mark in the tire circumferential direction are recessed with respect to the surface of the side wall portion, the center portion of the mark in the tire circumferential direction is raised with respect to the surface of the side wall portion, and the mark is formed such that the height of the surface of the mark with respect to the surface of the side wall portion is gradually increased toward the center portion from the both end portions.

4. The pneumatic tire according to claim 1, wherein a peripheral portion of the mark is recessed with respect to the surface of the side wall portion, the center portion of the mark is raised with respect to the surface of the side wall portion, and the mark is formed such that the height of the mark with respect to the surface of the side wall portion is gradually increased toward the center portion from the peripheral portion.

5. The pneumatic tire according to claim 1, wherein a serration is formed on the surface of the mark.

6. The pneumatic tire according to claim 1, wherein the mark is a letter, a symbol or a figure, a row of marks which is formed by arranging a plurality of the marks along the tire circumferential direction is formed on the surface of the side wall portion, and the row of marks forms display information displaying a name of manufacturer, a brand, a kind or a size of the tire.

7. A pneumatic tire where a mark is formed on a surface of a side wall portion, wherein
the mark is formed such that one end portion and the other end portion of the mark in at least one direction of a tire meridian direction, a tire circumferential direction or an oblique direction inclined with respect to the tire meridian direction or the tire circumferential direction are raised with respect to the surface of the side wall portion, a center portion of the mark in the at least one direction is recessed with respect to the surface of the side wall portion, and a height of the surface of the mark with respect to the surface of the side wall portion is gradually decreased toward the center portion from the one end portion and the other end portion.

8. The pneumatic tire according to claim 7, wherein an outer-peripheral-side end portion and an inner-peripheral-side end portion of the mark in the tire meridian direction are raised with respect to the surface of the side wall portion, the center portion of the mark in the tire meridian direction is recessed with respect to the surface of the side wall portion, and the mark is formed such that the height of the surface of the mark with respect to the surface of the side wall portion is gradually decreased toward the center portion from the outer-peripheral-side end portion and the inner-peripheral-side end portion.

9. The pneumatic tire according to claim 7, wherein both end portions of the mark in the tire circumferential direction are raised with respect to the surface of the side wall portion, the center portion of the mark in the tire circumferential direction is recessed with respect to the surface of the side wall portion, and the mark is formed such that the height of the surface of the mark with respect to the surface of the side wall portion is gradually decreased toward the center portion from the both end portions.

10. The pneumatic tire according to claim 7, wherein a peripheral portion of the mark is raised with respect to the surface of the side wall portion, the center portion of the mark is recessed with respect to the surface of the side wall portion, and the mark is formed such that the height of the mark with respect to the surface of the side wall portion is gradually decreased toward the center portion from the peripheral portion.

11. The pneumatic tire according to claim 7, wherein a serration is formed on the surface of the mark.

12. The pneumatic tire according to claim 7, wherein the mark is a letter, a symbol or a figure, a row of marks which is formed by arranging a plurality of the marks along the tire circumferential direction is formed on the surface of the side wall portion, and the row of marks forms display information displaying a name of manufacturer, a brand, a kind or a size of the tire.

13. A pneumatic tire where a mark is formed on a surface of a side wall portion, wherein
the mark is formed such that one end portion of the mark in at least one direction of a tire meridian direction, a tire circumferential direction or an oblique direction inclined with respect to the tire meridian direction or the tire circumferential direction is raised with respect to the surface of the side wall portion, the other end portion of the mark in the at least one direction is recessed with respect to the surface of the side wall portion, and a height of a surface of the mark with respect to the surface of the side wall portion is gradually decreased toward the other end portion from the one end portion.

14. The pneumatic tire according to claim 13, wherein one end portion of the mark in the tire meridian direction is raised with respect to the surface of the side wall portion, the other end portion of the mark in the tire meridian direction is recessed with respect to the surface of the side wall portion, and the mark is formed such that the height of the surface of the mark with respect to the surface of the side wall portion is gradually decreased toward the other end portion from the one end portion.

15. The pneumatic tire according to claim 13, wherein one end portion of the mark in the tire circumferential direction is raised with respect to the surface of the side wall portion, the other end portion of the mark in the tire circumferential direction is recessed with respect to the surface of the side wall portion, and the mark is formed such that the height of the surface of the mark with respect to the surface of the side wall portion is gradually decreased toward the other end portion from the one end portion.

16. The pneumatic tire according to claim 13, wherein a serration is formed on the surface of the mark.

17. The pneumatic tire according to claim 13, wherein the mark is a letter, a symbol or a figure, a row of marks which is formed by arranging a plurality of the marks along the tire circumferential direction is formed on the surface of the side wall portion, and the row of marks forms display information displaying a name of manufacturer, a brand, a kind or a size of the tire.
